(19) United States
(12) Patent Application Publication
(10) Pub. No.: US 2011/0317434 A1
(43) Pub. Date: Dec. 29, 2011

(54) LIGHT ASSEMBLY

(75) Inventor: KEIJI TAIGA, TOKYO (JP)

(73) Assignee: CROPS CO., LTD., TOKYO (JP)

(21) Appl. No.: 12/825,710

(22) Filed: Jun. 29, 2010

(51) Int. Cl. F21V 21/08

(52) U.S. Cl. 362/368

(57) ABSTRACT

A light assembly includes a light unit having a case and a base, and a light source is connected to the light unit. A support unit includes a reception portion and a bendable portion which extends from the reception portion. The base is connected to the support unit and the bendable portion is mounted to a part of the base. The bendable portion can be bent downward to form a support portion which is put on the desk or a floor. A hooking member is connected to an outside of the reception portion such that the light assembly can be hooked to an object.

### FIELD OF THE INVENTION

The present invention relates to a light assembly, and more particularly, to a light assembly which can be hooked by a hook or put on a floor.

### BACKGROUND OF THE INVENTION

A conventional light assembly generally includes two ways of use, the first way of use is to be fixed on an object such as fixed to a wall or ceiling, and the second way of use is to be movably installed such as portable light assembly which can be hooked on the wall of simply put on the desk.

The conventional movable or portable light assembly known to applicant generally includes a shade which is fixed to a case in which a light bulb is located. The case is connected to a cylindrical part which includes a first conductive plate and a second conductive plate, wherein the first conductive plate is connected to the case when the case is connected to the cylindrical part, and the second conductive plate extends into the interior of the cylindrical part so as to be connected with batteries. The batteries provide electric power to the light bulb.

Another conventional movable or portable light assembly known to applicant generally includes a case in which a light bulb is located, and a body which is connected to the case. The case includes conductive portion and the body includes a reception portion to which the conductive portion of the case is inserted so as to form a circuit. The body has a hook on its top so that the light assembly can be hanged to a hook when used outdoor.

However, the two conventional light assemblies each have only one function which is put on the desk or hooked with an object, the two functions are not combined into one light assembly.

The present invention intends to provide a light assembly which can be put on the desk or floor, and can also be hooked on a hook.

### SUMMARY OF THE INVENTION

The present invention relates to a light assembly which comprises a light unit having a case and a base, and a light source is connected to the light unit. A support unit has a reception portion and a bendable portion which extends from the reception portion and is bendable. The base is connected to the support unit and the bendable portion is mounted to a part of the base. A hooking member is connected to an outside of the reception portion so as to hook the light assembly on an object. The bendable portion can be bent downward to form a support portion which is put on a desk or floor.

The primary object of the present invention is to provide a light assembly which can be put on a desk or a floor by bending the bendable portion downward to form a support portion, can be hooked to an object by the hooking member connected to the reception portion.

Another object of the present invention is to provide a light assembly wherein the support unit is made of plastic material which is easily formed to reduce manufacturing cost.

Yet another object of the present invention is to provide a light assembly wherein the support unit and the base are securely connected to each other.

The present invention will become more obvious from the following description when taken in connection with the accompanying drawings which show, for purposes of illustration only, a preferred embodiment in accordance with the present invention.

### BRIEF DESCRIPTION OF THE DRAWINGS

FIG. 1 is a perspective view to show the light assembly of the present invention;

FIG. 2 is an exploded view to show the light assembly of the present invention;

FIG. 3 is a cross sectional view of the light assembly of the present invention;

FIG. 4 is a cross sectional view of the light assembly of the present invention, wherein the bendable portion is bent downward;

FIG. 5 is a perspective view to show the light assembly of the present invention is hooked to a hook;

FIG. 6 shows a second embodiment of the light assembly of the present invention;

FIG. 7 shows a third embodiment of the light assembly of the present invention;

FIG. 8 shows a fourth embodiment of the light assembly of the present invention, and

FIG. 9 shows that the bendable portion of the fourth embodiment of the light assembly of the present invention is bent downward.

### DETAILED DESCRIPTION OF THE PREFERRED EMBODIMENT

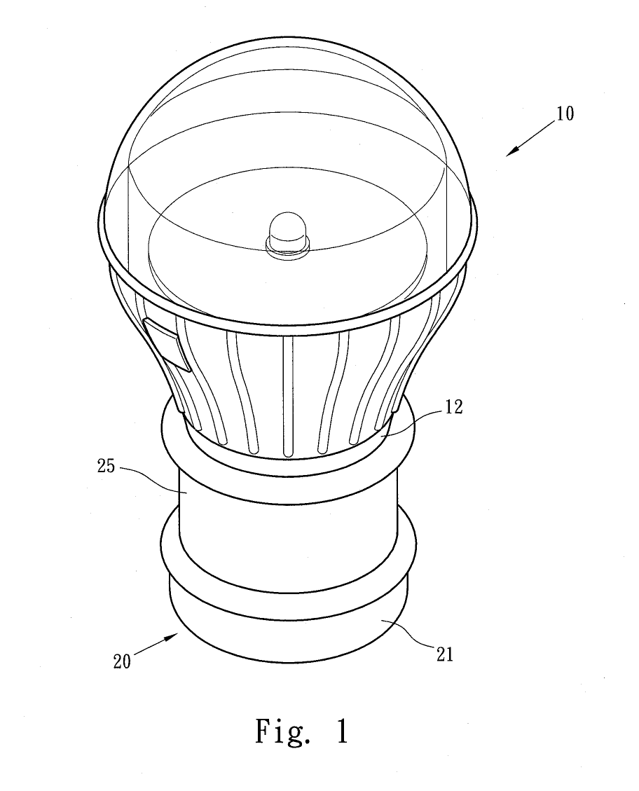

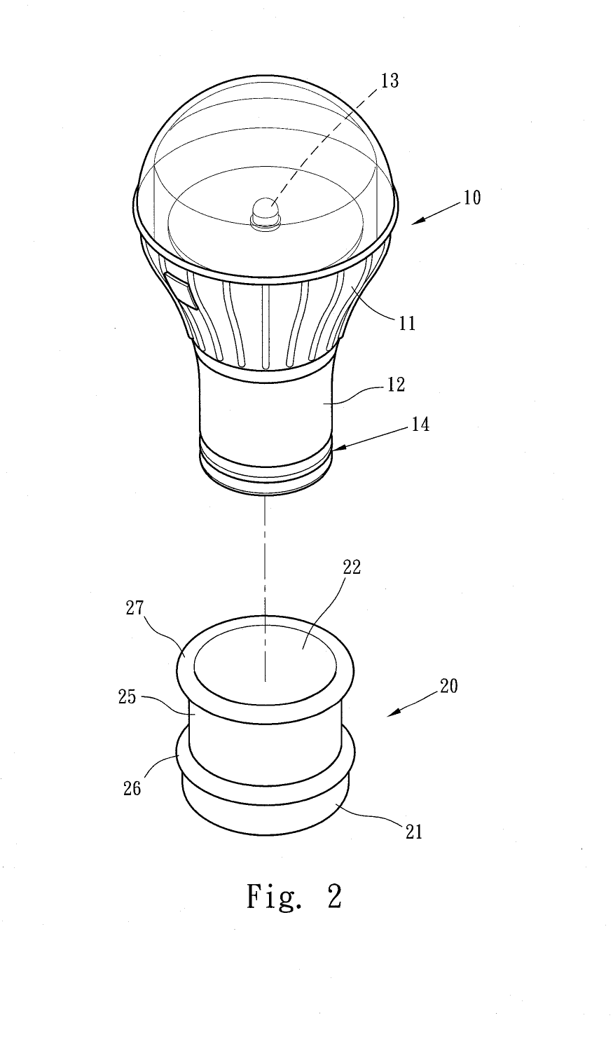

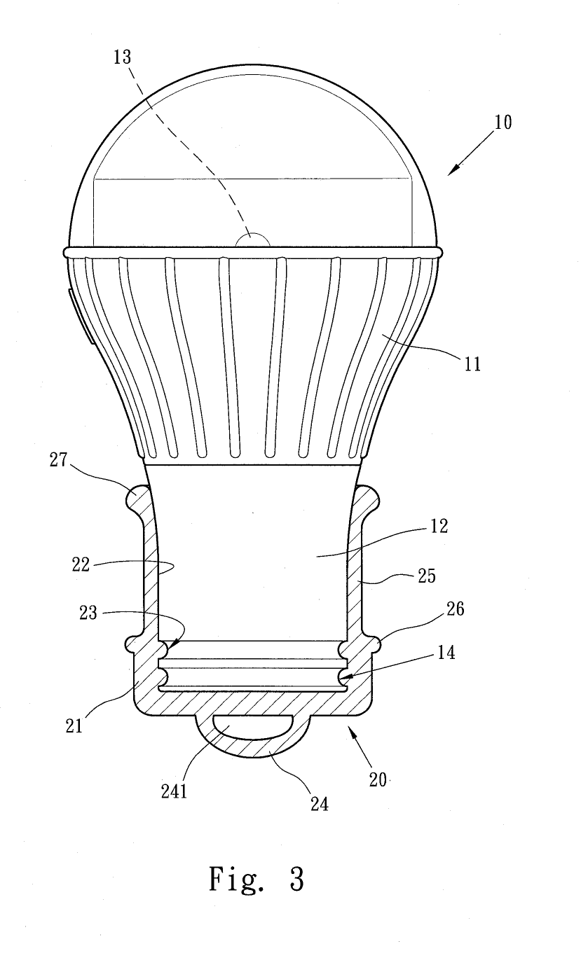

Referring to FIGS. 1 to 3, the light assembly of the present invention comprises a light unit 10 and a support unit 20, wherein the light unit 10 comprises a case 11 and a base 12. A light source 13 is connected to the light unit 10 and the base 12 includes a first positioning portion 14 on an outside thereof. The first positioning portion 14 includes multiple grooves or ridges.

The support unit 20 is mounted to the base 12 and made of silicon rubber or other thermo-plastic material. The support unit 20 comprises a reception portion 21 and a bendable portion 25 which integrally extends from the reception portion 21 and is bendable. A hooking member 24 is connected to an outside of the reception portion 21 and is a ring-shaped hook and includes a through hole 241. The reception portion 21 is a tubular portion and includes a second positioning portion 23 defined in an inside thereof. The second positioning portion 23 has multiple ridges or grooves. The support unit 20 is a tubular portion and includes a reception hole 22 in which the base 12 is received, so that the first positioning portion 14 are connected to the second positioning portion 23. The bendable portion 25 has a diameter smaller than that of the reception portion 21, and a flange 26 is located between the reception portion 21 and the bendable portion 25. A lip 27 extends outward from a distal end of the bendable portion 25.

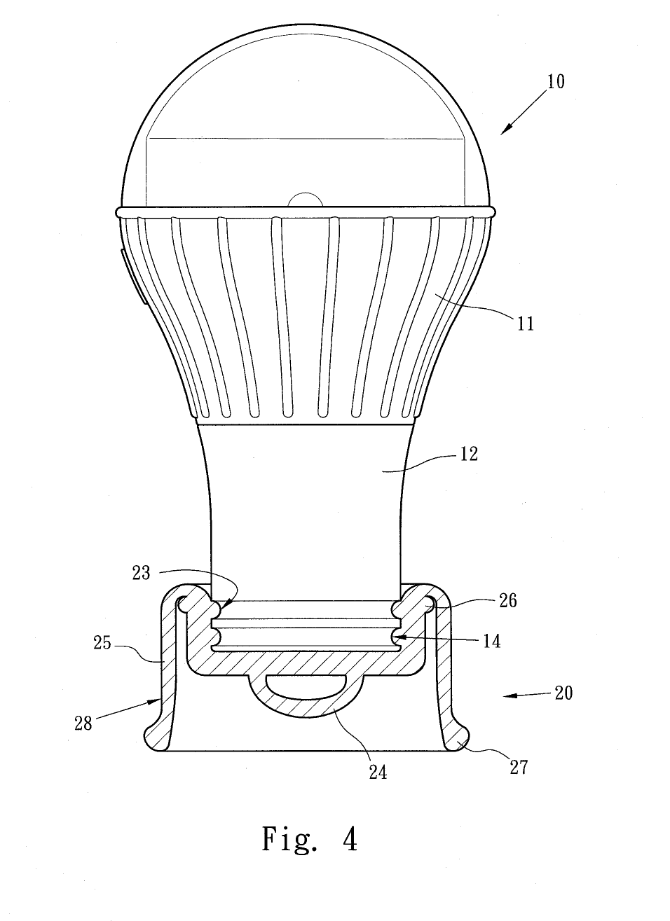

Referring to FIG. 4, when the light assembly is to be put on a desk or a floor, the bendable portion 25 is bent downward so as to form a support portion 28 which is put on a desk or a floor by the lip 27. The flange 26 restricts the bending position of the bendable portion 25 so that the bendable portion 25 is not overly bent to affect the connection of the base 12 and the reception portion 21.

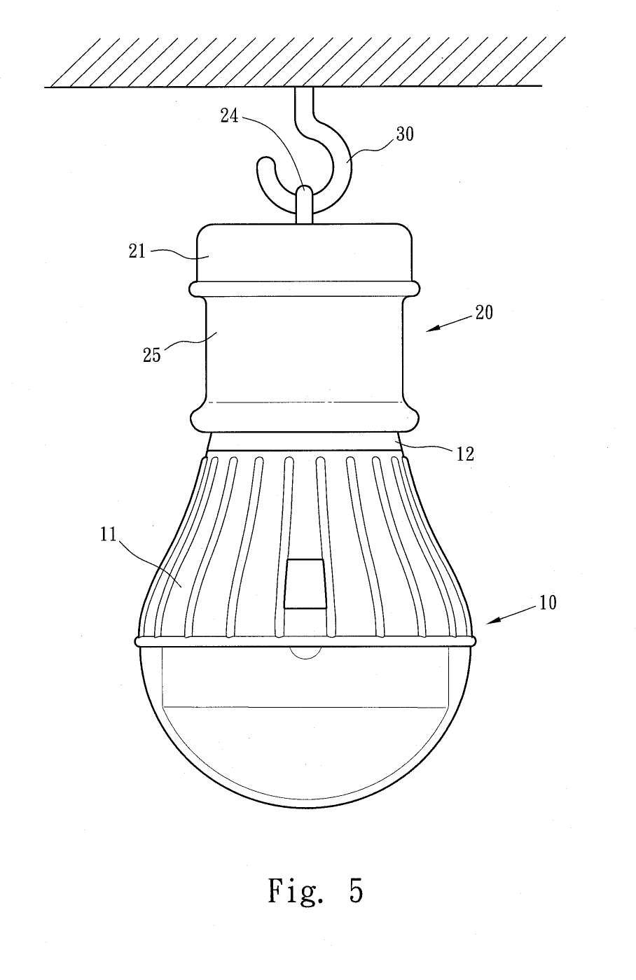

Referring to FIG. 5, when the light assembly used to be hanged on a higher position, the hooking member 24 is hooked to a hook 30 on a ceiling (for example) to hand the light assembly at a higher position.

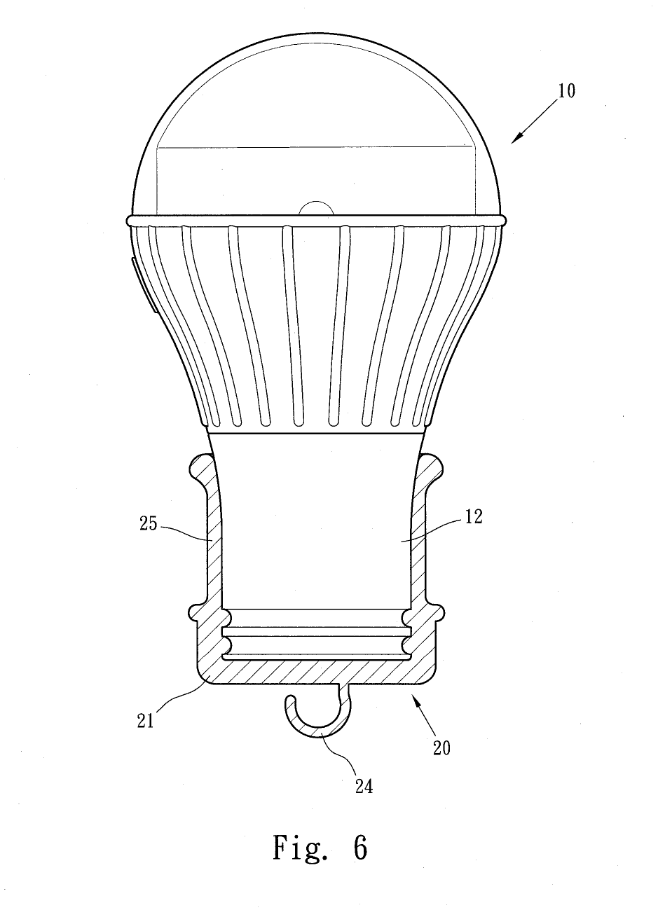

FIG. 6 shows that the hooking member 24 is a C-shaped hook and includes an opening.

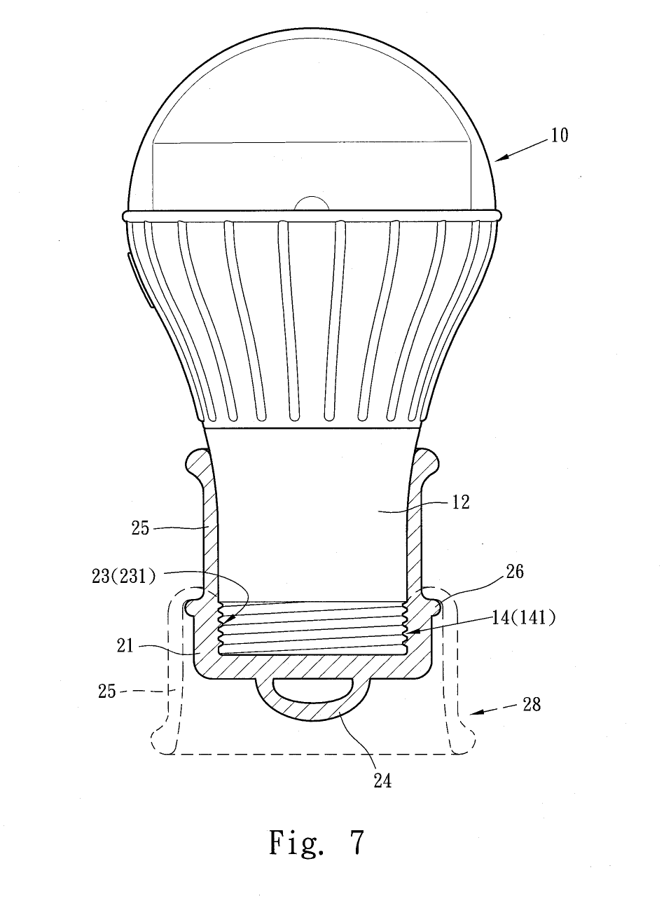

FIG. 7 shows that the base 12 includes a first positioning portion 14 on an outside thereof and the reception portion 21 includes a second positioning portion 23 defined in an inside thereof. The first positioning portion 14 includes a first threaded portion 141 and the second positioning portion 23 includes a second threaded portion 231 which is threadedly connected to the first threaded portion 141.

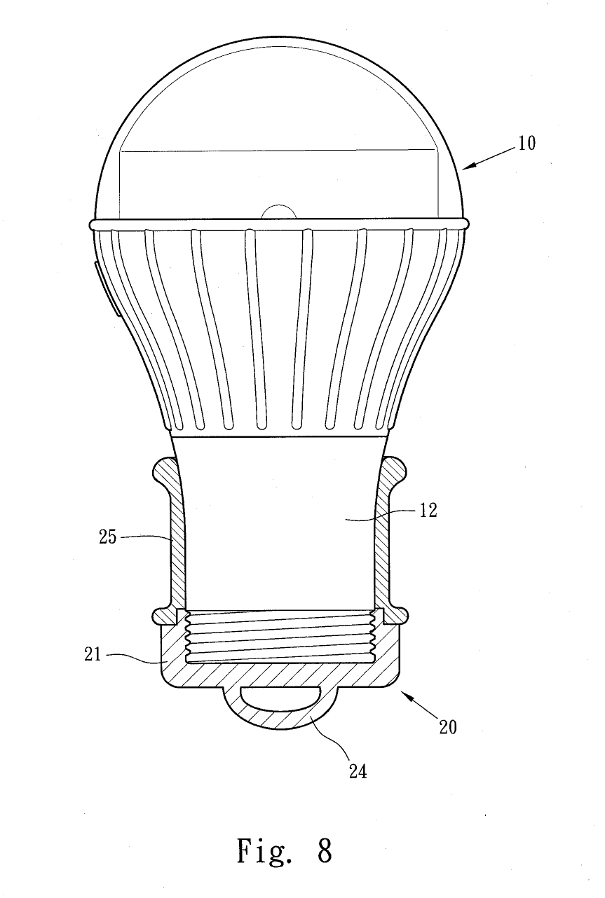

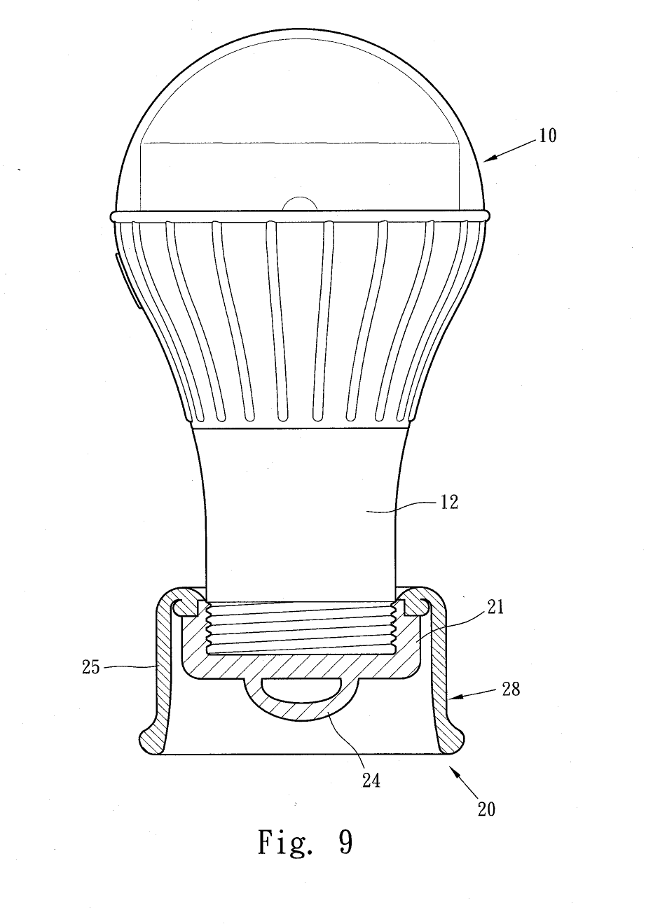

FIG. 8 shows that the reception portion 21 is made of a plastic material that is harder than a material of the bendable portion 25. The bendable portion 25 and the reception 21 are two individually made parts and the bendable portion 25 is connected to the reception 21 by any known method. As shown in FIG. 9, when the softer bendable portion 25 is bent downward, the harder reception portion 21 does not affected by the bending action and still securely connected to the base 12.

The light assembly of the present invention includes the two functions and provides the users a wider range of use and more flexible ways of use.

While we have shown and described the embodiment in accordance with the present invention, it should be clear to those skilled in the art that further embodiments may be made without departing from the scope of the present invention.

What is claimed is:

1. A light assembly comprising:
a light unit having a case and a base, a light source connected to the light unit, and
a support unit having a reception portion and a bendable portion which extends from the reception portion and is bendable, a hooking member connected to an outside of the reception portion, the base connected to the support unit and the bendable portion being mounted to a part of the base.

2. The light assembly as claimed in claim 1, wherein the support unit is made of flexible material and integrally forms the reception portion and the bendable portion.

3. The light assembly as claimed in claim 1, wherein the base is securely connected to an inside of the reception portion.

4. The light assembly as claimed in claim 3, wherein the base includes a first positioning portion on an outside thereof and the reception portion is a tubular portion and includes a second positioning portion defined in an inside thereof, the first positioning portion are connected to the second positioning portion.

5. The light assembly as claimed in claim 1, wherein the reception portion is a tubular portion and includes a reception hole in which the base is received, the bendable portion has a diameter smaller than that of the reception portion, a flange is located between the reception portion and the bendable portion.

6. The light assembly as claimed in claim 1, wherein a lip extends outward from a distal end of the bendable portion.

7. The light assembly as claimed in claim 1, wherein the hooking member is a ring-shaped hook and includes a through hole.

8. The light assembly as claimed in claim 1, wherein the hooking member is a C-shaped hook and includes an opening.

9. The light assembly as claimed in claim 1, wherein the base includes a first positioning portion on an outside thereof and the reception portion includes a second positioning portion defined in an inside thereof, the first positioning portion includes a first threaded portion and the second positioning portion includes a second threaded portion which is threadedly connected to the first threaded portion.

10. The light assembly as claimed in claim 1, wherein the reception portion is made of a plastic material that is harder than a material of the bendable portion.
